(19) United States
(12) Patent Application Publication
(10) Pub. No.: US 2009/0042678 A1
(43) Pub. Date: Feb. 12, 2009

(54) REVERSIBLE DRIVEN PULLEY FOR A CONTINUOUSLY VARIABLE TRANSMISSION

(76) Inventor: JOCELYN LABBE, Saint-Germain-de-Grantham (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/256,562

(22) Filed: Oct. 23, 2008

Related U.S. Application Data
(63) Continuation of application No. PCT/CA2007/000766, filed on May 2, 2007.
(60) Provisional application No. 60/746,220, filed on May 2, 2006.

(51) Int. Cl. F16H 61/662

(52) U.S. Cl. 474/19

(57) ABSTRACT

The driven pulley (10) comprises a first sheave (12) and a second sheave (40) coaxially mounted around a main shaft. The driven pulley (10) comprises an inverted cam plate (100) connected to the first sheave (12). The inverted cam plate (100) comprises ramps (104), each having a notch (108) to be engaged by projecting portions (106b) of corresponding followers (106). These parts are configured and disposed to prevent the driven pulley (10) from upshifting in a reverse mode.

### RELATED APPLICATIONS

This application is a continuation of International Patent Application No. PCT/CA2007/000766 filed on May 2, 2007 designating the United States of America, which PCT Application claims benefit of U.S. Provisional Patent Application No. 60/746,220 filed on May 2, 2006, all of which are hereby incorporated by reference.

### BACKGROUND

Continuously variable transmissions (CVTs) are commonly used on a wide range of vehicles, such as small cars or trucks, snowmobiles, golf carts, scooters, etc. They typically comprise a driving pulley mechanically connected to a motor, a driven pulley mechanically connected to wheels or a track, possibly through another mechanical device such as a gear box, and a trapezoidal drivebelt transmitting torque between the driving pulley and the driven pulley. A CVT automatically changes the ratio as required by load and speed conditions, providing an increased torque under high loads at low speeds and yet controlling the rotation speed of the motor as the vehicle accelerates. A CVT may be used with all kinds of motors, such as internal combustion engines or electric motors.

The sides of the drivebelt are, on each pulley, gripped between two opposite sheaves that are coaxially mounted around a corresponding main shaft. Generally, in each pulley of a conventional CVT, one sheave, usually called “fixed sheave”, is rigidly connected to one end of the corresponding main shaft. The other sheave, usually called “movable sheave”, is free to slide and/or rotate with reference to the fixed sheave by means of bushings or the like.

At a low vehicle speed, the winding diameter of the drivebelt at the driving pulley is minimal and the winding diameter of the driven pulley is maximum. This is referred to as the minimum ratio since there is the minimum number of rotations or fraction of rotation of the driven pulley for each full rotation of the driving pulley.

Generally, when the rotation speed of the driving pulley increases, its movable sheave moves closer to the fixed sheave thereof under the effect of a centrifugal mechanism. This forces the drivebelt to wind on a larger diameter on the driving pulley and, consequently, on a smaller diameter on the driven pulley. The drivebelt then exerts a radial force on the sheaves of the driven pulley in addition to the tangential driving force by which the torque is transmitted. This radial force urges the movable sheave of the driven pulley away from the fixed sheave thereof. It is counterbalanced in part by a return force, which is typically generated by a spring inside the driven pulley or another biasing mechanism. It is also counterbalanced by a force generated by the axial reaction of the torque applied by the drivebelt on the driven pulley. This is caused by a cam system that tends to move the movable sheave towards the fixed sheave as the torque increases. The cam system typically comprises a cam plate having a plurality of symmetrically-disposed and inclined ramps on which respective cam followers are engaged. The followers are usually sliding buttons or rollers. The set of ramps or the set of followers is mounted on the movable sheave and the other is directly or indirectly connected to the main shaft in a rigid manner. The closing effect of the cam system on the drivebelt tension is then somewhat proportional to output torque.

Generally, at the maximum vehicle speed, the ratio is maximum as there is the maximum number of rotations or fraction of rotation of the driven pulley for each full rotation of the driving pulley. Then, when the vehicle speed decreases, the rotation speed of the driving pulley typically decreases as well since the rotation speed of the motor decreases. This causes, at some point, a decrease of the winding diameter of the driving pulley and a decrease of the radial force exerted by the drivebelt on the sides of the sheaves at the driven pulley. Ultimately, the driven pulley is allowed to have a larger winding diameter as the spring or another biasing mechanism moves the movable sheave back towards the fixed sheave.

Some CVTs are provided with reversible driven pulleys. A reversible driven pulley operates in a similar fashion than that of a conventional one, with the exception that the transmission ratio can be controlled during motor braking or when the vehicle is traveling in reverse. These instances are generically referred to a “the reverse mode”. During motor braking, the torque is no longer coming from the motor to the wheels or track, but in the opposite direction. Similarly, when accelerating in reverse, the torque and the rotation will be in the reverse direction, the torque being transmitted from the motor to the wheels or track. A reversible driven pulley generally comprises a second set of ramps and a second set of followers. In use, one set of followers and its corresponding set of ramps are used when the torque is in one direction (forward mode), the other set being used for the other direction (reverse mode).

U.S. Pat. No. 6,949,039 shows an example of a driven pulley. The driven pulley described therein provides many advantages in terms of overall weight reduction and compactness. Nevertheless, there is still room for further improvements, including some to optimize the behavior of the driven pulley in the reverse mode and prevent it from upshifting in certain conditions.

### SUMMARY

In one aspect, there is provided a reversible driven pulley for a continuously-variable transmission (CVT), the driven pulley comprising a first sheave and a second sheave coaxially disposed and defining between them a belt-receiving groove, the driven pulley having at least two pairs of opposite first and second ramps symmetrically-disposed with reference to the rotation axis, the first ramps being connected to the first sheave and the second ramps being connected to an inverted cam plate having a base attached to an end of to the first sheave, the second sheave having at least two pairs of opposite first and second followers symmetrically disposed with reference to the rotation axis of the driven pulley, each first follower corresponding to a corresponding one of the first ramps and each second follower corresponding to a corresponding one of the second ramps, each second ramp comprising a notch, each second follower having a projecting portion with a shape complementary to that of the notch, the notches and the projecting portions being configured and disposed to prevent the driven pulley from upshifting in a reverse mode when engaged together.

In another aspect, there is provided an inverted cam plate for a driven pulley of a continuously-variable transmission (CVT), the cam plate comprising: a base; at least two symmetrically-disposed side members connected to the base, each side member defining a corresponding helical ramp on one side thereof; wherein each ramp comprises a notch to be engaged by a portion of a corresponding follower to maintain a constant ratio in the CVT when operated in a reverse mode below a threshold ratio.

In another aspect, there is provided a method of operating a driven pulley of a continuously-variable transmission (CVT) the method including: applying a reverse torque on the driven pulley; and preventing a transmission ratio of the driven pulley from increasing; wherein the transmission ratio of the driven pulley is prevented from increasing by latching a portion of a follower into a notch made in a ramp engaged by the follower when the reverse torque is applied.

### BRIEF DESCRIPTION OF THE FIGURES

The improved driven pulley will now be described in the following detailed description of a preferred embodiment, made in conjunction with the accompanying figures in which:

FIG. 1 is a partially exploded isometric view of an example of an improved driven pulley.

FIG. 2 is an isometric view of the improved driven pulley shown in FIG. 1, once fully assembled; and

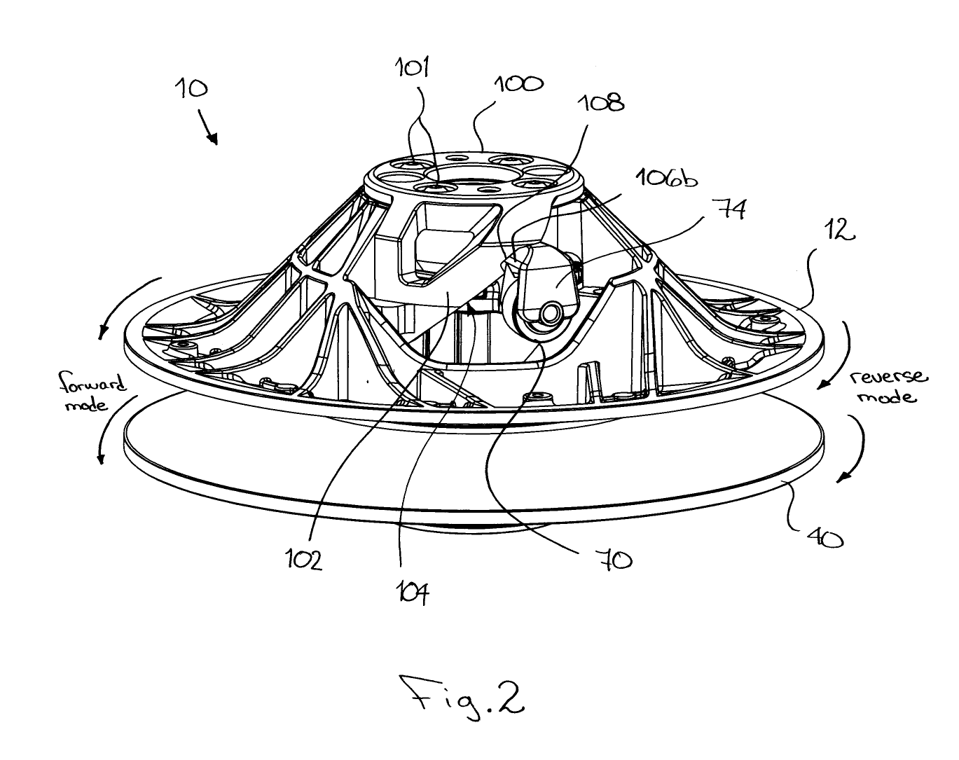

FIG. 3 is a side view of the driven pulley shown in FIG. 2, which pulley is illustrated with a partial cross-sectional area.

### DETAILED DESCRIPTION

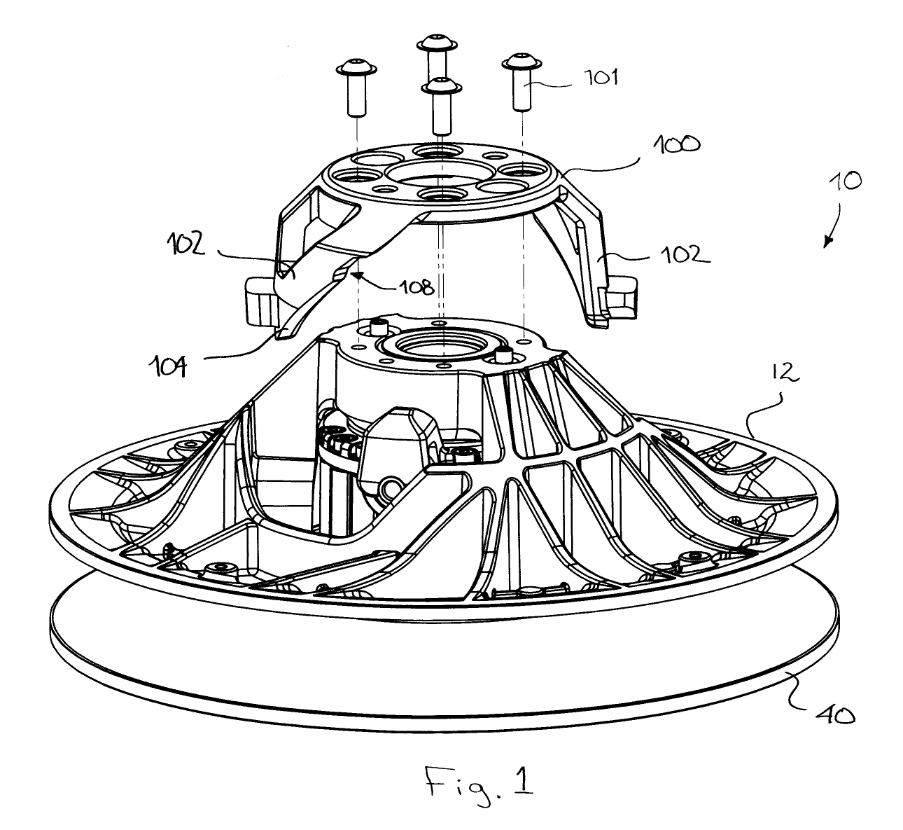

Referring to FIG. 1, there is shown an example of a driven pulley (10) as improved. The driven pulley (10) is mounted on a main shaft (not shown) which defines a rotation axis. Generally, single parts of the driven pulley (10) are coaxially mounted around the rotation axis and multiples of a same part are symmetrically disposed around it in order to have a properly-balanced device, as apparent to a person skilled in art.

In use, the torque is transmitted to or from the main shaft by the driven pulley (10). This torque is supplied from or to a trapezoidal drivebelt (not shown). The trapezoidal drivebelt has one end wound on a driving pulley (not shown) and the other end wound on the driven pulley (10), more particularly around a first (12) and a second sheave (40). The torque usually goes from the driven pulley (10) to the main shaft. However, in some circumstances, the torque can be transmitted in the opposite direction.

The first sheave (12) further comprises at least one pair of ramps (36). The ramps (36) are symmetrically-disposed with reference to the rotation axis. They are engagable by a set of followers (70), either rollers or sliding buttons, connected to a corresponding mounting unit (74).

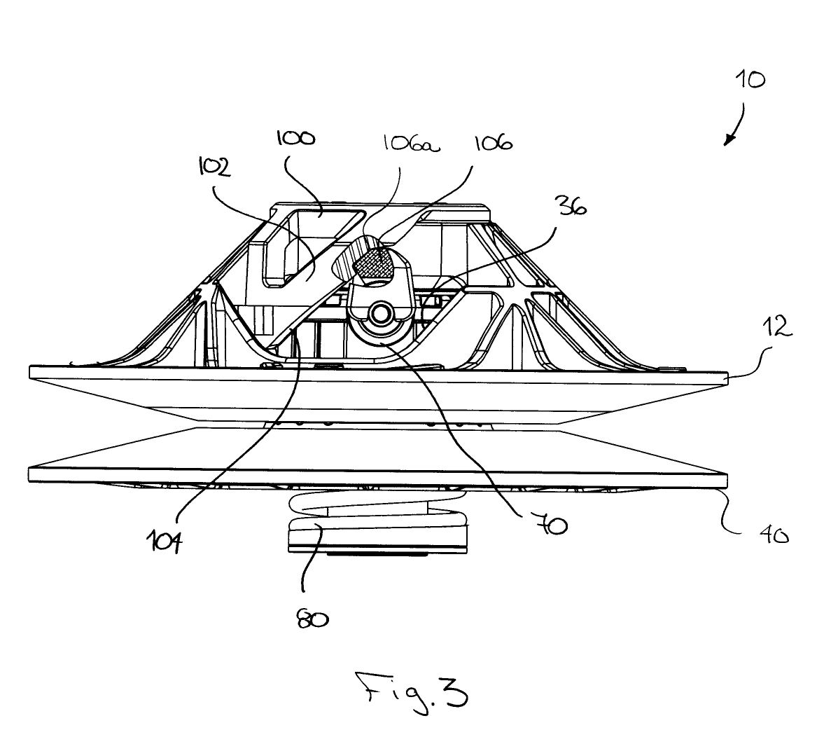

In the improved driven pulley (10), an inverted cam plate (100) is removably connected at the back of the first sheave (12). Bolts (101) are used in the illustrated embodiment. The inverted cam plate (100) comprises two side members (102), one for each ramp (36). Each side member (102) defines a second ramp (104) which faces the corresponding first ramp (36). These second ramps (104) are engagable by a corresponding sliding button (106) provided on the mounting unit (74) itself, as best shown in FIG. 3. Each sliding button (106) has a sliding portion (106a).

The purpose of the inverted cam plate (100) will depend on design requirements. However, in all cases, the inverted cam plate (100) prevents the CVT from downshifting if the followers (70) are moved to a second set of ramps provided on the first sheaves (12). This second set of ramps may be present because the same basic parts are used in many different designs. In some cases, for instance a 4-stroke snowmobile without an engine reversal mode, the driven pulley (10) can be designed without motor braking. The ramp (104) of the inverted cam plate (100) would have a smooth profile (i.e. being without a notch as described below). The follower (70) engages the corresponding ramp (36) and is in contact therewith most of the time. However, when power from the engine is interrupted, for instance by releasing the gas lever or pedal, the second sheave (40) is forced to move in the opposite direction relative to the first sheave (12) and if the spring (80) cannot counteract the torque alone, the sliding button (106) will engage the corresponding second ramp (104). Then, the torque coming from the wheels or tracks of the vehicle will be sent through the driven pulley (10) and the two sheaves (12, 40) will be moved away from each other to upshift the CVT, thereby mitigating the motor braking.

Some vehicles are provided with an engine capable of rotating in an opposite direction to back-up the vehicle. This engine reversal mode allows saving weight since no reverse gears are necessary. On the other hand, operating a CVT of an engine in a reversed mode may be relatively complex. An example is when the vehicle requires a relatively high torque for backing-up. This may be the situation of a vehicle that needs to get out of a ditch or hole in the reverse direction. The torque required from the engine to the wheels or track will then be relatively high. The problem is that the driven pulley (10) may force the whole CVT to upshift as soon as torque is supplied by the engine, which can ultimately prevent the vehicle from moving. To solve this problem and keep the ratio at or near the minimum ratio, the sliding button (106) can be provided with a wedge-shaped portion (106b) that fits into a corresponding notch (108) provided in the second ramp (104). When the wedge-shaped portion (106b) engages the notch (108), the driven pulley (10) is locked and it cannot upshift when torque is supplied by the engine in an engine reversal mode. Similarly, the notch (108) can also prevent the CVT from upshifting when the vehicle travels in a forward direction and the power from the engine is interrupted, thereby creating a reverse mode. More than one notch (108) can be provided on the ramps (104), depending on the needs.

It should be noted that each roller (70) can include a damping element somewhere between its axle and the surface thereof. The roller (70) can also be made of a plastic material. All this, either alone or in combination, and the fact the space between the first ramps (36) and their corresponding ramps (104) is relatively small, reduces the noise during the transition of the rollers (70) between one set of ramps to the other.

It must be understood that the present invention is not limited to this precise embodiment and that various changes and modifications may be effected therein without departing from the scope of the present invention as defined in the appended claims. For instance, the exact shape of the reversible driven pulley can vary, depending on the needs. It is possible to use more than two pairs of opposite ramps (36, 104). The first followers (70) can be sliding buttons instead of rollers. The second followers (106) can be rollers instead of sliding buttons. The notches (108) are not necessarily wedge-shaped. More than one notches can be present on a same ramp to prevent upshifting at various ratios. The ratio at which the upshfting is prevented is not necessarily the minimum ratio. The inverted cam plate can be integrated or otherwise non-removably connected to the first sheave (12).

What is claimed is:

1. A reversible driven pulley for a continuously-variable transmission (CVT), the driven pulley comprising a first sheave and a second sheave coaxially disposed and defining between them a belt-receiving groove, the driven pulley having at least two pairs of opposite first and second ramps symmetrically-disposed with reference to the rotation axis, the first ramps being connected to the first sheave and the second ramps being connected to an inverted cam plate having a base attached to an end of to the first sheave, the second sheave having at least two pairs of opposite first and second followers symmetrically disposed with reference to the rotation axis of the driven pulley, each first follower corresponding to a corresponding one of the first ramps and each second follower corresponding to a corresponding one of the second ramps, each second ramp comprising a notch, each second follower having a projecting portion with a shape complementary to that of the notch, the notches and the projecting portions being configured and disposed to prevent the driven pulley from upshifting in a reverse mode when engaged together.

2. The driven pulley as defined in claim 1, wherein the notches prevent the driven pulley from upshifting when the CVT is substantially at a minimum ratio.

3. The driven pulley as defined in claim 1, wherein the first followers include rollers.

4. The driven pulley as defined in claim 1, wherein the second followers include sliding buttons provided on mounting units for the first followers, each projecting portion corresponding to one of the sliding buttons.

5. The driven pulley as defined in claim 4, wherein the sliding buttons are made integral with the mounting units.

6. The driven pulley as defined in claim 1, wherein each notch is substantially wedge-shaped.

7. The driven pulley as defined in claim 1, wherein the inverted cam plate is removably connected to the end of the first sheave.

8. An inverted cam plate for a driven pulley of a continuously-variable transmission (CVT), the cam plate comprising:
a base;
at least two symmetrically-disposed side members connected to the base, each side member defining a corresponding helical ramp on one side thereof;
wherein each ramp comprises a notch to be engaged by a portion of a corresponding follower to maintain a constant ratio in the CVT when operated in a reverse mode below a threshold ratio.

9. The inverted cam plate as defined in claim 8, wherein the threshold ratio is substantially a minimum ratio of the CVT, the notches preventing the driven pulley from upshifting.

10. The inverted cam plate as defined in claim 8, wherein the followers include sliding buttons, each sliding button comprising a projecting portion for engagement with one of the notches.

11. The inverted cam plate as defined in claim 8, wherein each notch is substantially wedge-shaped.

12. The inverted cam plate as defined in claim 8, wherein the inverted cam plate is removably connectable to an end of a sheave of the CVT.

13. The inverted cam plate as defined in claim 12, wherein the inverted cam plate is removably connected to the sheave by bolts.

14. A method of operating a driven pulley of a continuously-variable transmission (CVT) the method including:
applying a reverse torque on the driven pulley; and
preventing a transmission ratio of the driven pulley from increasing;
wherein the transmission ratio of the driven pulley is prevented from increasing by latching a portion of a follower into a notch made in a ramp engaged by the follower when the reverse torque is applied.

15. The method as defined in claim 14, wherein the reverse torque is applied while the transmission ratio is substantially minimum.

16. The method as defined in claim 14, wherein the reverse torque is applied on the driven pulley from an engine to which the CVT is mechanically connected, the engine operating in an engine revered mode.

17. The method as defined in claim 14, wherein the reverse torque is applied on the driven pulley from wheels or a track of a vehicle traveling in a forward direction.
